(19) United States
(12) Patent Application Publication
(10) Pub. No.: US 2026/0075015 A1
(43) Pub. Date: Mar. 12, 2026

(54) TRACKING DATA BROKER FOR MANAGING MULTIPLE SOURCES OF TRACKING DATA

(71) Applicant: HARMAN INTERNATIONAL INDUSTRIES, INCORPORATED, Stamford, CT (US)

(72) Inventor: Alfredo FERNANDEZ FRANCO, Los Angeles, CA (US)

(21) Appl. No.: 18/882,294

(22) Filed: Sep. 11, 2024

(51) Int. Cl. H04L 51/10; H04L 51/046

(52) U.S. Cl. CPC H04L 51/10; H04L 51/046

(57) ABSTRACT

In various embodiments, a computer-implemented method comprises receiving, by a tracking data broker from a consumer, a request for first data tagged with a first set of metadata, determining, by the tracking data broker, a plurality of data feeds associated with the first set of metadata, wherein a plurality of tracking data sources include, in the plurality of data feeds, sensor data tagged with the first set of metadata, generating a first message containing a set of data values from the plurality of data feeds, and transmitting the first message to the consumer.

### BACKGROUND

### Field of the Various Embodiments

The various embodiments relate generally to tracking systems and, more specifically, to a tracking data broker for managing multiple sources of tracking data.

### Description of the Related Art

Various vehicles include various subsystems, such as navigation systems, advanced driver assistance systems (ADAS), in-car entertainment (ICE) systems, and in-vehicle infotainment (IVI) systems, that produce outputs based on sensor data. For example, the ADAS includes a driver monitoring system (DMS) that monitors the driver using one or more driver-directed sensors. The DMS processes the sensor data acquired by the driver-directed sensors to assess the driver's handling of the vehicle. In some systems, the ICE or IVI system uses in-compartment sensors to determine the presence of a seat occupant and control loudspeakers or microphones that are proximate to occupied seats.

One drawback with conventional vehicle systems is that such systems have difficulty handling tracking sensor data efficiently. Conventional vehicle systems typically include tracking sensors that provide a specific type of sensor data to a specific subsystem or service. However, conventional vehicle systems have difficulty distributing relevant tracking sensor data to other subsystems or services. For example, the driver-directed sensors that acquire sensor data about the driver transmit the sensor data to the driver monitoring system. The ICE and IVI systems also attempt to use this sensor data to accurately determine the position and orientation of the driver. However, the conventional vehicle system has difficulty transmitting the sensor data from the driver-directed sensors to multiple systems efficiently. As a result, the ICE and IVI systems do not receive this sensor data and thus cannot incorporate the sensor data into algorithms that predict the position and orientation of the driver. Consequently, the ICE and IVI systems make less accurate predictions of the position and orientation of the driver when controlling loudspeakers within the compartment, resulting in a degraded listening experience.

As the foregoing illustrates, what is needed in the art are more effective techniques for managing sensor data within a vehicle.

### SUMMARY

In various embodiments, a computer-implemented method comprises receiving, by a tracking data broker from a consumer, a request for first data tagged with a first set of metadata, determining, by the tracking data broker, a plurality of data feeds associated with the first set of metadata, where a plurality of tracking data sources include, in the plurality of data feeds, sensor data tagged with the first set of metadata, generating a first message containing a set of data values from the plurality of data feeds, and transmitting the first message to the consumer.

At least one technical advantage of the disclosed techniques relative to the prior art is that, with the disclosed techniques, various data consuming services can acquire sensor data about users from multiple tracking data sources in an efficient and scalable manner. In particular, the tracking data broker can transmit sensor data acquired by the tracking data sources based on various parameters and filters to a requesting data consuming service without requiring the data consuming service to identify the relevant tracking data sources. In this manner, data consuming services can flexibly acquire sensor data from a large number of tracking data sources to determine information about users with more accuracy and can generate outputs that more accurately reflect the status of each user. Further, by enabling a data consuming service to request a specific suite of sensor data, the tracking data broker can manage multiple tracking data sources by transmitting sets of sensor data that are relevant to the data consuming service while filtering other sensor data that does not meet the criteria specified by the data consuming service. Management of tracking data sources and data consuming services in this manger reduces bandwidth and computing resources that are otherwise associated with the data consuming services receiving and discarding unnecessary sensor data. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a tracking data system configured to implement one or more aspects of the present disclosure.

FIG. 2 illustrates an example vehicle system that includes the tracking data system of FIG. 1, according to various embodiments.

FIG. 3 illustrates an example communication environment of the tracking data system of FIG. 1 processing sensor data acquired by a plurality of tracking data sources, according to various embodiments.

FIG. 4 illustrates an example communication environment of the tracking data system of FIG. 1 transmitting collected user data to a consumer service, according to various embodiments.

FIG. 5 is a flow diagram of method steps for transmitting sensor data associated with a user to a consumer service, according to various embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details. For explanatory purposes, multiple instances of like objects are symbolized with reference numbers identifying the object and parenthetical numbers(s) identifying the instance where needed.

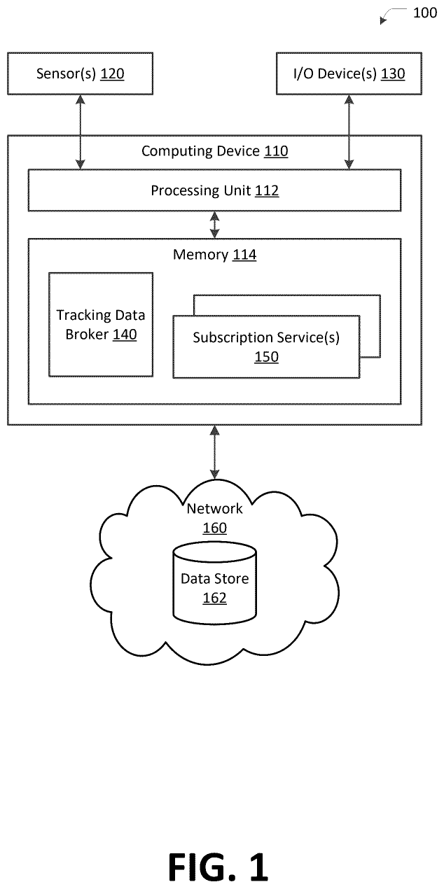

FIG. 1 illustrates a block diagram of a tracking data system 100 configured to implement one or more aspects of the present disclosure. As shown, the tracking data system 100 includes, without limitation, a computing device 110, one or more sensors 120, one or more input/output (I/O) devices 130, and a network 160. The computing device 110 includes, without limitation, a processing unit 112 and a memory 114, where the memory 114 stores, without limitation, the tracking data broker 140 and one or more subscription services 150. The network 160 includes, without limitation, a data store 162.

In operation, the processing unit 112 receives sensor data from the sensor(s) 120. The processing unit 112 executes the tracking data broker 140 in order to process the sensor data acquired from the sensors 120 and distribute the sensor data or other data values derived from the sensor data to the one or more subscription services 150. The subscription services 150 process the sensor data or other data values transmitted from the tracking data broker 140 using various algorithms, such as audio rendering, driver monitoring, speech detection, and so forth. In various embodiments, the sensor data can be included in a vehicle and can output various types of output data, including orientation, coordinates, Boolean values, etc. The data values derived from the sensor data include data values relating to specific users, such as the head position and/or orientation of a user.

As noted above, computing device 110 can include the processing unit 112 and the memory 114. The computing device 110 can be a device that includes one or more processing units 112, such as a system-on-a-chip (SoC). In various embodiments, computing device 110 can be a mobile computing device, such as a tablet computer, mobile phone, media player, and so forth. In some embodiments, the computing device 110 can be a head unit included in a vehicle system. Generally, the computing device 110 can be configured to coordinate the overall operation of the tracking data system 100. The embodiments disclosed herein contemplate any technically-feasible system configured to implement the functionality of the tracking data system 100 via computing device 110.

Various examples of the computing device 110 include mobile devices (e.g., cellphones, tablets, laptops, etc.), wearable devices (e.g., watches, rings, bracelets, headphones, etc.), consumer products (e.g., gaming, gambling, etc.), smart home devices (e.g., smart lighting systems, security systems, digital assistants, etc.), communications systems (e.g., conference call systems, video conferencing systems, etc.), and so forth. The computing device 110 can be located in various environments including, without limitation, road vehicle environments (e.g., consumer car, commercial truck, etc.), aerospace and/or aeronautical environments (e.g., airplanes, helicopters, spaceships, etc.), nautical and submarine environments, and so forth.

The processing unit 112 can include a central processing unit (CPU), a digital signal processing unit (DSP), a microprocessor, an application-specific integrated circuit (ASIC), a neural processing unit (NPU), a graphics processing unit (GPU), a field-programmable gate array (FPGA), and so forth. The processing unit 112 generally comprises a programmable processor that executes program instructions to manipulate input data. In some embodiments, the processing unit 112 can include any number of processing cores, memories, and other modules for facilitating program execution. For example, the processing unit 112 could receive input from a user via the I/O devices 130 and generate pixels for display on the I/O device 130 (e.g., a display device).

The memory 114 can include a memory module or collection of memory modules. The memory 114 generally comprises storage chips such as random-access memory (RAM) chips that store application programs and data for processing by the processing unit 112. In various embodiments, the memory 114 can include non-volatile memory, such as optical drives, magnetic drives, flash drives, or other storage. In some embodiments, separate data stores, such as the data store 162 included in network 160 (“cloud storage”) can supplement the memory 114. In some embodiments, one or more subscription services 150 are stored in the data store 162. The tracking data broker 140 and/or the subscription services 150 within memory 114 can be executed by the processing unit 112 to implement the overall functionality of the computing device 110 and, thus, to coordinate the operation of the tracking data system 100 as a whole.

The one or more sensors 120 can include one or more devices that perform measurements and/or acquire data related to subjects in an environment. In various embodiments, the one or more sensors 120 can generate sensor data that is related to one or more users and/or object within the environment. For example, the one or more sensors 120 can collect various types of sensor data related to occupants of a vehicle (e.g., presence, height, location, head orientation, etc.), as well as other sensor data, such as biometric data (e.g., heart rate, brain activity, skin conductance, blood oxygenation, pupil size, galvanic skin response, blood-pressure level, average blood glucose concentration, etc.). Additionally or alternatively, the one or more sensors 120 can generate sensor data related to objects in the environment that are not the user. For example, the one or more sensors 120 could generate sensor data about the operation of a vehicle, including the state of one or more turn signals, the speed of the vehicle, the ambient temperature in the vehicle, the amount of light within the vehicle, compartment temperature, and so forth. In some embodiments, the one or more sensors 120 can be coupled to and/or included within the computing device 110 and send the sensor data to the processing unit 112. The processing unit 112 executes the tracking data broker 140 to distribute data values associated with the sensor data to the subscription services 150.

In various embodiments, the one or more sensors 120 can include optical sensors, such as RGB cameras, infrared cameras, depth cameras, and/or camera arrays, which include two or more of such cameras. Other optical sensors can include imagers and laser sensors. In addition, in some embodiments, the one or more sensors 120 can include acoustic sensors, such as a microphone and/or a microphone array that acquires sound data. In some embodiments, the one or more sensors 120 can include physical sensors, such as touch sensors, pressure sensors, position sensors (e.g., an accelerometer and/or an inertial measurement unit (IMU)), motion sensors, and so forth, that register the body position and/or movement of one or more users. In such instances, the tracking data broker 140 can process the acquired sensor data to indicate the position of the user, and then transmit data values to the subscription services 150 for further processing.

The one or more I/O devices 130 can include devices capable of receiving input, such as a keyboard, a mouse, a touch-sensitive screen, a microphone, and/or other input devices for providing input data to the computing device 110. In various embodiments, the one or more I/O devices 130 can include devices capable of providing output, such as a display screen, loudspeakers, haptic actuators, and the like. One or more of the I/O devices 130 can be incorporated in computing device 110, or can be external to computing device 110. In some embodiments, the computing device 110 and/or the one or more I/O device(s) 130 can be components of an ADAS.

The network 160 can enable communications between the computing device 110 and other devices in network via wired and/or wireless communications protocols, including Bluetooth, Bluetooth low energy (BLE), wireless local area network (WiFi), cellular protocols, satellite networks, V2V and/or V2X networks, and/or near-field communications (NFC). In various embodiments, the network 160 can include one or more data stores 162 that store data associated with sensor data, biometric values, etc. In various embodiments, the tracking data broker 140 and/or the subscription services 150 can retrieve information from the data store 162.

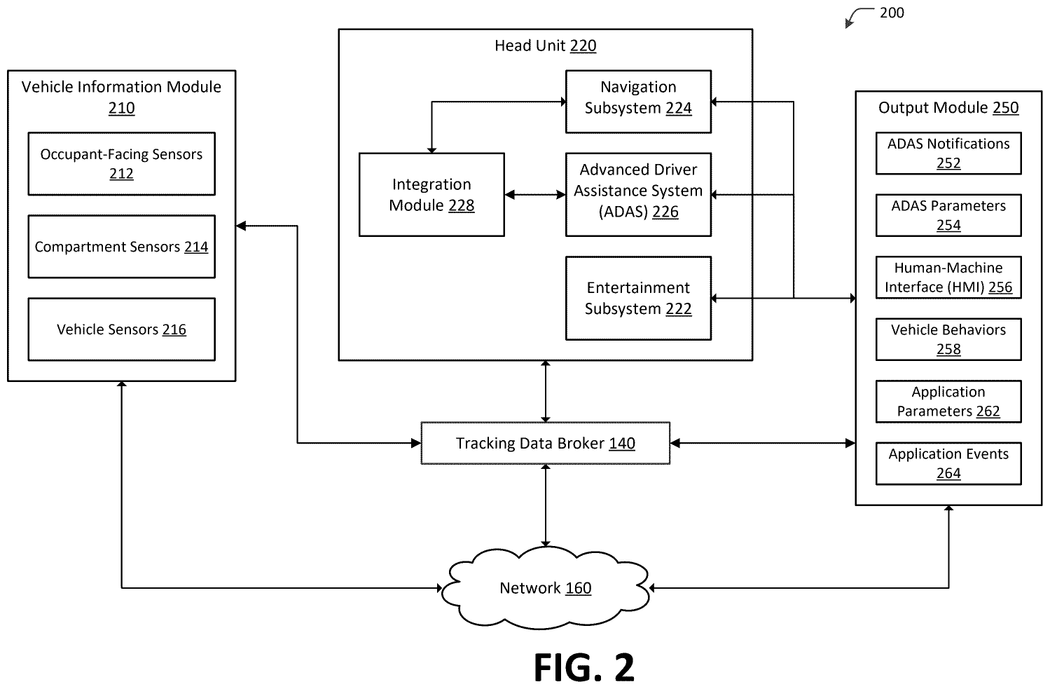

FIG. 2 illustrates an example vehicle system 200 that includes the tracking data system 100 of FIG. 1, according to various embodiments. As shown, the vehicle system 200 includes, without limitation, a vehicle information module 210, a head unit 220, the tracking data broker 140, the network 160, and an output module 250. The vehicle information module 210 includes, without limitation, one or more occupant-facing sensors 212, one or more compartment sensors 214, and/or one or more vehicle sensors 216. The head unit 220 includes, without limitation, an entertainment subsystem 222, a navigation subsystem 224, an ADAS 226, and an integration module 228. The output module 250 includes, without limitation, one or more ADAS notifications 252, one or more ADAS parameters 254, a human-machine interface (HMI) 256, one or more vehicle behaviors 258, one or more application parameters 262, and/or one or more application events 264.

In various embodiments, one or more of the sensors 212-216 included in the vehicle information module 210 acquire various types of sensor data. The tracking data broker 140 the sensor data from the vehicle information module 210 and can distribute the sensor data and/or other data values derived from the sensor data (e.g., user orientation data derived from optical sensor data) to one or more modules included in the head unit 220 and/or the output module 250. In some embodiments, the integration module 228 can process data received from the tracking data broker 140 and generate processed data values for other modules, such as the navigation subsystem 224 and/or the ADAS 226. In some embodiments, integration module 228 sends the processed data values to the output module 250 that generates a specific output signal to drive one or more output devices 130. In some embodiments, the integration module 228 generates an output signal that the output module 250 receives and converts to a specific output (e.g., ADAS notification 252) that drives a specific output (e.g., ADAS 226).

In various embodiments, the vehicle information module 210 includes multiple types of sensors, including occupant-facing sensors 212 (e.g., cameras, motion sensors, microphones, etc.), compartment sensors 214 (e.g., motion sensors, pressure sensors, temperature sensors, etc.), and/or vehicle sensors 216 (e.g., gyroscopes, accelerometers, etc.). In various embodiments, the vehicle information module 210 transmits sensor data acquired via the sensors 212-216 to the tracking data broker 140. In various embodiments, the tracking data broker 140 can process the sensor data using various techniques to identify specific data values. For example, the tracking data broker 140 could apply one or more image processing algorithms to identify the head position of a seat occupant within a global coordinate system. Additionally and alternatively, one or more ML models (not shown) can be trained from any combination of the sensor data to generate data values. For example, the ML models can be trained to classify images and/or acquired sensor data and/or tag the acquired sensor data with one or more metadata tags. In such instances, the tracking data broker 140 inputs the newly-acquired sensor data as an input and the ML model can then be able to generate values, such as a value indicating the head position of the user.

In various embodiments, head unit 220 can be mounted at any location within a passenger compartment of a vehicle in any technically-feasible fashion. In some embodiments, head unit 220 can include any number and type of instrumentation and applications, and can provide any number of input and output mechanisms. For example, head unit 220 could enable users (e.g., the driver and/or passengers) to control the entertainment subsystem 222 and/or navigation subsystem 224. In some embodiments, the tracking data broker 140 is included in the head unit 220. The head unit 220 supports any number of input and output data types and formats, as known in the art. For example, the head unit 220 could include built-in Bluetooth for hands-free calling and/or audio streaming, universal serial bus (USB) connections, speech recognition, rear-view camera inputs, video outputs for any number and type of displays, and any number of audio outputs. In general, any number of sensors (e.g., the sensor(s) 120, one or more of the sensors 212-216), displays, receivers, transmitters, etc., can be integrated into head unit 220, or can be implemented externally to head unit 220. In various embodiments, external devices can communicate with head unit 220 in any technically-feasible fashion.

The entertainment subsystem 222 and/or the navigation subsystem 224 can receive data sets from the tracking data broker 140 and use the data for further processing. For example, the entertainment subsystem 222 can receive user position data and/or user orientation data from the tracking data broker 140 and input the user position data and/or the user orientation data into rendering algorithms to alter the configuration of audio filters and/or other audio components to generate audio output for one or more loudspeakers. In some embodiments, the entertainment subsystem 222 and/or navigation subsystem 224 can receive specific output signals provided by output module 250. For example, entertainment subsystem 222 can receive a notification sound via HMI 256 and can cause speakers within the compartment to emit the notification sound.

The ADAS 226 automates certain tasks and/or provides notifications via one or more output signals to assist the driver in operating the vehicle. In some embodiments, the ADAS 226 could respond to specific sensor data or specific user data values by performing certain vehicle operations (e.g., engaging in the horn to alert the nearby vehicle based on the user orientation data of the driver).

The output module 250 performs one or more actions in response to an output signal and/or data values transmitted from the tracking data broker 140. For example, the output module 250 could generate one or more output signals to one or more control signals from the ADAS 226, where the output signal modifies an application and/or an interface. For example, the output module 250 could receive one or more output signals to modify the HMI 256 to display notification messages and/or alerts. In another example, the output module 250 could receive one or more output signals to modify an application. In such instances, output module 250 can receive application parameters 262 and/or application events 264 that alter the operation of one or more applications, such as the subscription services 150.

In various embodiments, ADAS notifications 252 can include light indications, such as ambient lights and mood lights, audio notifications, voice notifications (e.g., a voice assistant), visual notification messages, haptic notifications in the vehicle (e.g., steering wheel, seat, head rest, etc.) or wearable device or touchless haptic notifications, etc. In various embodiments, ADAS parameters 254 can include various operating parameters, settings, or actions. For example, ADAS parameters 254 could include vehicle climate control settings (e.g., window controls, passenger compartment temperature, increasing fan speed, etc.), and/or olfactory parameters, such as emitting specific fragrances that are calming or stimulating. In various embodiments, ADAS parameters 254 can include emergency calling parameters, such as triggering the dialing of one or more emergency phone numbers, or suggesting that the user connect to a specific contact situation that can require immediate assistance and/or response.

In various embodiments, ADAS parameters 254 can dynamically activate L2+/L3+ semi-autonomous driving capabilities, such as lane keep assist (LKA), collision avoidance, and/or autonomous driving. In some embodiments, ADAS parameter 254 can be a binary activation signal (on/off); alternatively, ADAS parameters 254 can be activation signal that provides a more-gradual activation (e.g., with varying degrees of automated correction when the driver seems to deviate from their lane). In some embodiments, ADAS parameters 254 can dynamically activate the collision avoidance systems. For example, output module 250 can dynamically generate ADAS parameters 254 that adapt the parameters of the system (e.g., warning time, brake intensity, etc.) depending on the collision risk value.

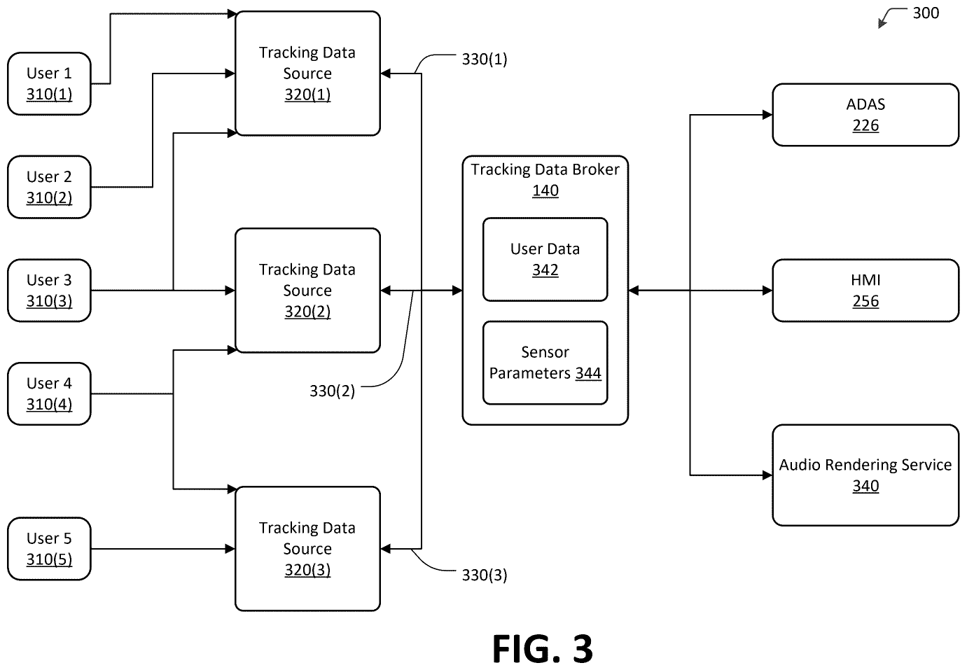

FIG. 3 illustrates an example communication environment 300 of the tracking data system 100 of FIG. 1 processing sensor data acquired by a plurality of tracking data sources 320, according to various embodiments. As shown, the communication environment includes, without limitation, a plurality of users 310 (e.g., users 310(1)-310(5)), a plurality of tracking data sources 320 (e.g., the tracking data sources 320(1)-320(3)), a plurality of data feeds 330 (e.g., the data feeds 330(1)-330(3)), the tracking data broker 140, the ADAS 226, the HMI 256, and the audio rendering service 340. The tracking data broker 140 includes user data 342 and sensor parameters 344.

In operation, the tracking data broker 140 is a portion of a publish-subscribe network that allows consumers to subscribe to one or more data feeds 330(1)-330(3) maintained by the tracking data sources 320(1)-320(3). The tracking data sources 320 transmit sensor data on the respective data feeds 330. The tracking data broker 140 stores the sensor data and other metadata related to the tracking data sources 320 and/or sensors (e.g., the sensors 120, 212-216) as sensor parameters 344. The tracking data broker 140 also collects and/or processes some of the sensor data to generate user data 342 for the respective users 310(1)-310(5). One or more consumer services, such as the ADAS 226, the HMI 256, and/or the audio rendering service 340 subscribe to receive specific data sets from the tracking data broker 140. The tracking data broker 140 processes requests for specific data sets as subscriber requests and collects data values from the user data 342 and/or the sensor parameters 344 that are responsive to the requests. The tracking data broker 140 then publishes the requested data values by transmitting one or more messages containing a set of data values that are responsive to the request to the applicable consumer service.

The tracking data sources 320 receive sensor data acquired from one or more sensors. In some embodiments, a tracking data source is a sensor device and/or edge device that includes one or more sensors. For example, the tracking data source 320(3) can be a backseat tracking device that receives sensor data acquired from one or more occupant-facing sensors 212 (e.g., a microphone array) and one or more compartment sensors 214 (e.g., pressure sensors, gyroscopes, accelerometers, magnetometers, or IMUs). In various embodiments, the tracking data sources 320 generate metadata that identifies sensor parameters 344 for the one or more sensors that acquire the sensor data. For example, the tracking data source 320(3) can generate metadata that includes information about the one or more occupant-facing sensors 212 and/or the compartment sensors 214. This metadata can include the sensor types, the sensor identification values (sensor IDs), the sensor locations, the sensor output types, the sensitivity levels, and so forth.

In various embodiments, a tracking data source 320 can track multiple users 310 and transmit sensor data related to one or more of the multiple users in a data feed 330. For example, the tracking data source 320(1) can receive optical sensor data and/or video sensor data from a camera that captures images of users 310(1)-310(3). The tracking data source can transmit the optical sensor data and/or video sensor data via the data feed 330(1) to the tracking data broker 140. Conversely, a user 310 can be tracked by sensor data acquired by multiple tracking data sources 320. For example, the user 3 310(3) can be tracked by multiple sensors, where a first sensor (e.g., a rear-row camera) transmits optical sensor data to the tracking data source 320(1) while a second sensor (e.g., a seat pressure sensor) transmits pressure sensor data to the tracking data source 320(2). In such instances, the tracking data broker 140 can receive the respective sensor data via the data feeds 330(1), 330(2) and can group the data as a portion of the user data 342 relating to the user 3 310(3).

In various embodiments, the tracking data broker 140 registers the tracking data sources 320. In some embodiments, the tracking data broker 140 acquires sensor parameter metadata for the sensors that transmit data to the respective tracking data sources 320 and store the sensor parameter metadata as a portion of the sensor parameters 344. For example, the sensor parameter metadata can include information identifying the sensor type, sensor identification value, sensor accuracy level, sensor data output type (e.g., orientation, coordinates, Boolean value, etc.), and so forth.

Additionally or alternatively, the tracking data broker 140 can map one or more users 310 to the one or more tracking data sources 320. In such instances, the tracking data broker can use the mappings to generate user data 342 for each of the users 310 using sensor data received via the data feeds 330. For example, the tracking data broker 140 processes the metadata for the tracking data source 320(1) to identify a set of users 310(1)-310(3) that are associated with the tracking data source 320(1). The tracking data broker 140 then generates sensor-to-user mapping for each user 310 being tracked by sensors that transmit sensor data to the tracking data source 320(1). In such instances, the tracking data broker 140 can use a list of sensor-to-user mappings to collect data values for a specific user from one or more sensor outputs provided by the tracking data sources 320. In some embodiments, the sensor-to-user mapping specifies the tracking data source 320 and the user 310 that is being tracked (e.g., a sensor-to-user mapping between the user 4 310(4) and the tracking data source 320(3)). Additionally, in some embodiments, the sensor-to-user mapping specifies various sensor parameters 344 (e.g., sensor output type, sensor ID, sensor accuracy level) and/or user data 342 (e.g., user ID, user position, user orientation, user activity, etc.) that can be acquired or generated from sensor data that the tracking data source 320 transmits via a data feed 330. For example, the tracking data broker 140 can process metadata for the tracking data sources 320(3). Based on the metadata, the tracking data broker 140 can determine that the tracking data source 320(3) is acquiring sensor data from a steering wheel sensor and that the sensor data is related to the driver (e.g., the user 310(5)). In such instances, the tracking data broker 140 can generate a sensor-to-user mapping to specify the sensor parameters 344 and/or the user data 342 for the user 5 310(5) that can be acquired using the sensor data transmitted from the tracking data source 320(3).

In various embodiments, the communication environment 300 includes one or more consumers. The consumers can be services or applications, such as the ADAS 226, the HMI 256, and/or the audio rendering service 340 that transmit requests for specific types of data sets relating specific criteria, such as user data 342 for a specific user. For example, the audio rendering service 340 can transmit one or more requests that request user position data and/or user orientation data for each user 310 in order to determine the position of each user's head within the compartment of a vehicle. The audio rendering service 340 can then process the user data 342 received from the tracking data broker to adjust audio filter parameters to generate one or more sound fields within the compartment of the vehicle.

In various embodiments, the tracking data broker 140 receives, from a subscribing consumer, a request for data tagged with specified metadata. The subscribing customer generates a request for a data set and/or a data stream that is tagged with specific of tags (e.g., subsets of the user data 342 and/or the sensor parameters 344 that are tagged with identifying specific attribute). In some embodiments, the request can specify a specific sensor or tracking data source 320 (e.g., including a specific sensor ID), and/or one or more sensor parameters 344 for that sensor. Additionally or alternatively, in some embodiments, the request can specify specific data sets included in the user data 342 or the sensor parameters 344 without identifying a specific sensor or tracking data source 320.

For example, the audio rendering service 340 can generate a request for a data set including the user position data of users 310(1)-310(2) that are above a threshold accuracy level (e.g., all sensor data tagged with either “mid” or “high” accuracy level tags). In some embodiments, the request can be a request for information about the tracking data sources 320. For example, the request be a request for a list of all sensors tracked by one or more tracking data sources 320 that acquire sensor data related to at least one of users 310(2)-310(4), where the list of sensors is ranked by proximity to the user location. Other example requests for combinations of metadata tags and criteria are listed in Table 1:

TABLE 1
Example Requests from Consumer

| Example Request | Metadata and Criteria |
|---|---|
| For user id A, give me the user's | UserID, UserOrientation |
| orientation data from the sensor with | UserActivity, SensorID, |
| highest accuracy every time there is | SensorAccuracy |
| a new user activity. | |
| For user's A and B give me their position | UserID, UserNomPosition, |
| using an optical sensor. | SensorType, |
| Give me a list of all the sensors ranked | SensorID, SensorPosition, |
| by accuracy positioned in front of | SensorAccuracy, UserPosition |
| users A & B. | |
| When the accuracy of the optical sensor | SensorType, UserID, |
| tracking user A is below High, give | SensorAccuracy, SensorID |
| me data from an IMU sensor tracking | |
| that user if available. | |
| Check if sensor id A needs to be | SensorID, SensorParameters |
| calibrated. | |
| Give me a list of all the users detected by | UserID, UserLociation |
| the system and their current locations | |
| Give me a list of all the sensors in the | SensorID, SensorType, |
| system, their type and location. | SensorLocation |

In various embodiments, the tracking data broker 140 treats the requests from the consumers as subscription requests and establishes a topic, where the topic comprises data sets and/or data feeds 330 from the one or more tracking data sources 320 that are responsive to the request. In various embodiments, the tracking data broker 140 processes the request from the consumer and identifies any data feeds 330 that are responsive to the request. In some embodiments, the tracking data broker 140 uses the metadata for the tracking data sources 320 and/or the user-to-sensor mappings to identify one or more data feeds 330 include sensor data tagged with metadata tags identified in the request. For example, when the tracking data broker 140 receives a request from the audio rendering service 340 for user position data of the users 310(4)-310(5) based on sensor data from compartment sensors 214, the tracking data broker 140 determines that the request is for sensor data that are (i) tagged with tags indicating positions (e.g., absolute position, nominal position, etc.) within the compartment of the vehicle and (ii) tagged with one of the respective user ID tags for the users 310(4) or 310(5); sensor data that are tagged with these combinations of tags are transmitted from the tracking data source 140 to the audio rendering service 340.

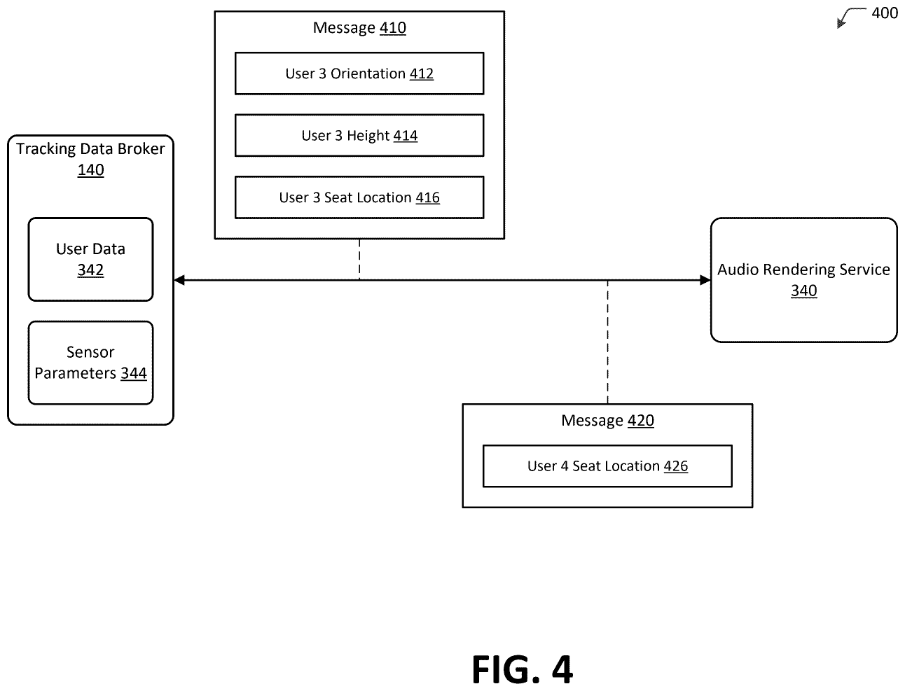

FIG. 4 illustrates an example communication environment 400 of the tracking data system 100 of FIG. 1 transmitting collected user data to a consumer service, according to various embodiments. As shown, the communication environment 400 includes, without limitation, the tracking data broker 140, the audio rendering service 340, and messages 410, 420. The tracking data broker 140 includes, without limitation, the user data 342 and the sensor parameters 344. The message 410 includes, without limitation, user 3 orientation data 412, user 3 height data 414, and user 3 seat location data 416. The message 420 includes, without limitation, user 4 seat location data 426.

In operation, the tracking data broker 140 responds to one or more requests by the audio rendering service 340 by identifying data sets, data types, and/or data feeds 330 that are responsive to the request. The tracking data broker 140 treats the request as a subscription request for a specified topic. The tracking data broker 140 identifies the applicable data sets, data types, and/or data feeds 330 as the portions of a topic to which the consumer is subscribed. The tracking data broker 140 collects data values that are applicable to the topic and generates a message 410, 420 containing the collected data values. The tracking data broker 140 then transmits the message 410, 420 to the audio rendering service.

In various embodiments, the tracking data broker 140 can determine whether to report data values to the consumer. In various embodiments, the tracking data broker 140 determines whether any data values in the user data 342 and/or the sensor parameters 344 are responsive to the request. In some embodiments, the tracking data broker 140 can determine whether to transmit a message containing a data set of data values that are identified as responsive to the request. For example, the request from the audio rendering service 340 can specify that the tracking data broker 140 is to periodically transmit data values associated with users 310(3)-310(4). Additionally or alternatively, in some embodiments, the tracking data broker 140 automatically applies a periodicity to the transmission of messages 410, 420, such as transmitting one or more update messages 410 containing updated data values for the user 3 310(3) once every minute and transmitting one or more update messages 420 containing updated data values for the user 4 310(4) once every 10 minutes.

In various embodiments, the tracking data broker 140 collects data values responsive to the request. In various embodiments, upon identifying the data feeds 330 that transmit sensor outputs that are responsive to the request, the tracking data broker 140 collects the sensor data from the identified data feeds 330 and/or uses the sensor-to-user mapping to collect a portion of the user data 342. For example, the tracking data broker 140 can collect optical data included in the data feed 330(1) relating to the user 3 310(3) as a portion of sensor parameters 344. The tracking data broker 140 can also convert the optical data into user orientation data and store the user orientation data as part of the user data 342. In some embodiments, the tracking data broker 140 transmits the sensor data to a service to convert the sensor data. For example, the tracking data broker 140 can transmit optical sensor data acquired from the tracking data source 320(1) to an image processing service to convert the optical sensor data to user orientation data for one or more users 310 (e.g., orientation data for users 310(1)-310(3)). The tracking data broker 140 can then receive the user orientation data from the image processing service and store the user orientation data as part of the user data 342 (e.g., the user 3 orientation data 412).

In various embodiments, the tracking data broker 140 generates and transmits one or more messages that are responsive to requests made by the audio rendering service 340. For example, the tracking data broker 140 can generate the message 410 containing the collected data values (e.g., data values 412-416) for the user 3 310(3) that are responsive to the criteria included in the request made by the audio rendering service 340. The tracking data broker 140 can then send the message 410 to the audio rendering service 340. The message 410 can include one or more data values 412-414, such as sensor outputs or data values that have been tagged with a user ID for the user 3 310(3). For example, the message 410 can include data values representing the user 3 orientation data 412, the user 3 height data 414, and the user 3 seat location data 416, where the data values 412-416 are portions of user data 342 that the tracking data broker 140 derives from sensor data received from the tracking data sources 320(1)-320(2). In such instances, the data values representing the user 3 orientation data 412 may have changed since the previous transmission, while the data values representing the user 3 height data 414, and the user 3 seat location data 416 may have remained constant since the previous transmission.

Additionally or alternatively, the tracking data broker 140 can generate and transmit message 420 that includes data values for the user 4 310(4). For example, the tracking data source 320(2) can acquire pressure sensor for a middle back row seat and the tracking data broker can generate a sensor-to-user mapping between the tracking data source 320(2) and the user 4 320(4). When the audio rendering service 340 requests all user data relating to the position and orientation of the user 4 310(4), the tracking data broker uses the sensor parameters 344 and the sensor-to-user mappings to identify the pressure sensor data tagged with the applicable location metadata (e.g., a tag identifying pressure data for the back row middle set) as being related to the user 4 310(4). The tracking data broker 140 can then periodically generate and transmit the message 420 containing the user 4 seat location data 426 that is based on the applicable pressure data.

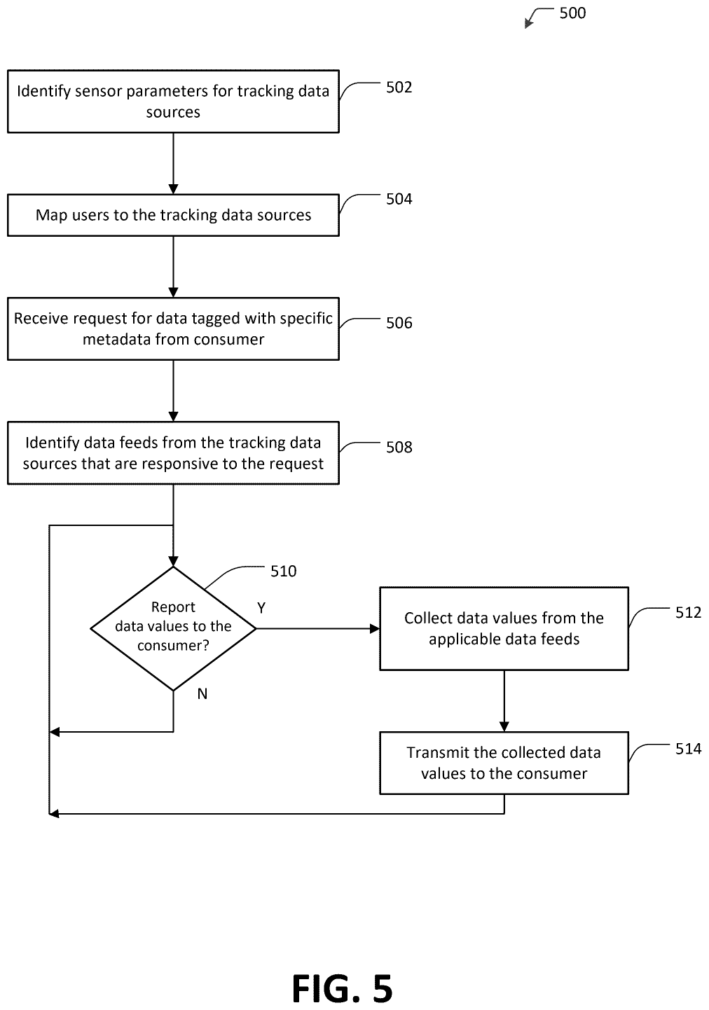

FIG. 5 is a flow diagram of method steps for transmitting sensor data associated with a user to a consumer service, according to various embodiments. Although the method steps are described with reference to the embodiments of FIGS. 1-4, persons skilled in the art will understand that any system configured to implement the method steps, in any order, falls within the scope of the present disclosure.

As shown, the method 500 begins at step 502, where the tracking data broker 140 identifies sensor parameters for one or more tracking data sources 320. In various embodiments, the tracking data broker 140 acquires metadata from one or more tracking data sources 320 (e.g., the tracking data sources 320(1)-320(3)). In some embodiments, the tracking data broker 140 processes metadata to identify various sensor parameters 344 associated with the one or more tracking data sources 320, including one or more data feeds 330 that transmit sensor outputs. For example, the tracking data source 320(1) can receive sensor data from a set of cameras that are positioned within a compartment of a vehicle and that acquire visual sensor data. In such instances, the tracking data broker 140 can acquire one or more sensor parameters 344 that specify sensor types, sensor identification values (sensor IDs), sensor locations, sensor output types, sensitivity levels, and so forth.

At step 504, the tracking data broker 140 maps one or more users 310 to the one or more tracking data sources 320. In various embodiments, the tracking data broker 140 processes the metadata for the one or more tracking data sources 320 to identify one or more users 310 (e.g., the users 310(1)-310(5)) that are associated with a given tracking data source 320 (e.g., the tracking data source 320(1)). The tracking data broker 140 determines whether the tracking data source 320(1) acquires sensor data for a given user and generates a sensor-to-user mapping for each tracking data source 320 that acquires sensor data that is associated with the user 310 (e.g., the user 310(3)). In such instances, the tracking data broker 140 can use a list of sensor-to-user mappings to collect data values for a specific user from one or more sensor outputs provided by the tracking data sources 320. In some embodiments, the sensor-to-user mapping specifies the tracking data source 320 and the user 310 that is being tracked (e.g., a sensor-to-user mapping between the user 4 310(4) and the tracking data source 320(3)). Additionally, in some embodiments, the sensor-to-user mapping specifies various sensor parameters 344 (e.g., sensor output type, sensor ID, sensor accuracy level) and/or user data 342 (e.g., user ID, user absolute position, user nominal position, user orientation, user activity, etc.) that can be acquired or generated from sensor data that the tracking data source 320 transmits via a data feed 330.

For example, the tracking data broker 140 can process metadata for the tracking data sources 320(1), 320(2). Based on the metadata, the tracking data broker 140 can determine that the tracking data source 320(1) is acquiring visual sensor data related to users 310(1)-310(3) and the tracking data source 320(2) is acquiring pressure data related to users 310(3)-310(4). In such instances, the tracking data broker 140 can generate five sensor-to-user mappings (e.g., a mapping of the tracking data source 320(1) to the user 3 310(3), etc.) to specify the sensor parameters 344 and/or the user data 342 that can be acquired using the sensor data transmitted from the tracking data source 320(1).

At step 506, the tracking data broker 140 receives a request for data tagged with specified metadata from a consumer. In various embodiments, the tracking data broker 140 can receive a request for a data set and/or a data stream from one or more subscribing customers. In some embodiments, the one or more subscribing customers can be services or applications, such as the audio rendering service 340, the ADAS 226, and/or the HMI 256. A subscribing customer generates a request for a data set and/or a data stream that is tagged with specific types of metadata (e.g., subsets of the user data 342 and/or the sensor parameters 344 that are tagged with identifying metadata). In some embodiments, the request can specify a specific sensor or tracking data source 320 (e.g., including a specific sensor ID), and/or one or more sensor parameters 344 for that sensor. Additionally or alternatively, in some embodiments, the request can specify specific data sets included in the user data 342 or the sensor parameters 344 without identifying a specific sensor or tracking data source 320. For example, the audio rendering service 340 can generate a request for a data set including the user position data of users 310(1)-310(2) based on sensor data acquired from an optical sensor. In some embodiments, the request can be a request for information about the tracking data sources 320. For example, the request be a request for a list of all sensors tracked by one or more tracking data sources 320 that acquire sensor data related to at least one of users 310(2)-310(4), where the list of sensors is ranked by level of accuracy.

At step 508, the tracking data broker 140 identifies data feeds from the one or more tracking data sources 320 that are responsive to the request received from the consumer. In various embodiments, the tracking data broker 140 processes the request from the consumer and identifies any data feeds that are responsive to the request. In some embodiments, the tracking data broker 140 uses the metadata for the tracking data sources 320 and/or the user-to-sensor mappings to identify one or more data feeds 330 provided by the tracking data sources 320 that transmit sensor data having metadata tags identified in the request. For example, when the tracking data broker 140 receives a request for user position data of the users 310(1)-310(2) based on sensor data acquired from an optical sensor, the tracking data broker 140 determines that the request is for sensor data that tagged with a tag for optical data and tagged with one of the respective user ID tags for the users 310(1) or 310(2); such sensor data tagged with these combination of metadata tags is transmitted via the data feed 330(1) from the tracking data source 320(1).

At step 510, the tracking data broker 140 determines whether to report data values to the consumer. In various embodiments, the tracking data broker 140 determines whether any data values are responsive to the request and whether to transmit a data set that is responsive to the request of the subscribing customer. For example, the request from the subscribing customer can specify that the tracking data broker 140 is to transmit data values associated with a specific user any time there is a change in the activity level of that user (e.g., when the data values indicate a change of user activity from “present” to “not present” or vice versa, when the change is exceeds a predetermined threshold, etc.). Additionally or alternatively, in some embodiments, the tracking data broker 140 applies a periodicity to the transmission of messages 410, 420, such as transmitting a message 410, 420 containing the data values that are responsive to the request once every minute. In both instances, the tracking data broker 140 determines whether the criteria for transmission of data values are satisfied. When the tracking data broker 140 determines that the criteria for transmission of data values has been satisfied, the tracking data broker 140 proceeds to step 512. Otherwise, the tracking data broker 140 determines that the criteria for transmission of data values has not been satisfied and returns to step 510.

At step 512, the tracking data broker 140 collects data values from the applicable data feeds 330. In various embodiments, upon identifying the data feeds 330 that transmit the sensor outputs that are responsive to the request of the subscribing consumer, the tracking data broker 140 collects the sensor data from the identified data feeds 330. In some embodiments, the tracking data broker 140 collects the sensor data as user data 342 and/or sensor parameters 344. For example, the tracking data broker 140 can collect optical data as a portion of sensor parameters for the tracking data source 320(1). The tracking data broker 140 can also convert the optical data into user orientation data and store the user orientation data as part of the user data 342. In some embodiments, the tracking data broker 140 transmits the sensor data to a service to convert the sensor data. For example, the tracking data broker 140 can transmit optical sensor data acquired from the tracking data source 320(1) to an image processing service to convert the optical sensor data to user orientation data for one or more users 310 (e.g., orientation data for users 310(1)-310(3)). The tracking data broker 140 can then receive the user orientation data from the image processing service and store the user orientation data as part of the user data 342 (e.g., the user 3 orientation data 412).

At step 514, the tracking data broker 140 transmits the collected data values to the consumer. In various embodiments, the tracking data broker 140 generates and transmits a message (e.g., the message 410) containing the collected data values (e.g., data values 412-416) to the subscribing consumer. For example, the tracking data broker 140 can generate a message 410 containing a set of data values 412-416 relating to the user 3 310(3) that are responsive to the request made by the audio rendering service 340. The tracking data broker 140 can then send the message 410 to the audio rendering service 340. The message 410 can include one or more data values 412-414, such as sensor outputs or data values that have been tagged with a user ID for the user 3 310(3). In some embodiments, the tracking data broker 140 can send one or more data values that have changed since a previous transmission and/or one or more data values that have remained constant since the previous transmission.

For example, the message 410 can include data values representing the user 3 orientation data 412, the user 3 height data 414, and the user 3 seat location data 416, where the data values 412-416 are portions of user data 342 that the tracking data broker 140 derives from sensor data received from the tracking data sources 320(1)-320(2). In such instances, the data values representing the user 3 orientation data 412 may have changed since the previous transmission, while the data values representing the user 3 height data 414, and the user 3 seat location data 416 may have remained constant since the previous transmission. Upon transmitting the message 410, the tracking data broker 140 can optionally return to step 510 to determine whether to transmit additional data to the subscribing customer.

In sum, a tracking data system includes a tracking data broker that communicates with a plurality of tracking data sources. The tracking data sources acquire sensor data from one or more types of sensors, including audio sensors, video sensors, pressure sensors, and so forth. Each of the tracking sources collects sensor data for one or more users. For example, a camera can acquire video data of three vehicle occupants in a vehicle row while separate pressure sensors in the respective seats acquire pressure data for the respective vehicle occupants. The tracking data broker maps one or more data flows generated by the tracking data sources to one or more users. A given tracking data source can track multiple users in a data flow. Conversely, a given user can be tracked by sensor data acquired by multiple tracking data sources. The tracking data broker combines sensor data transmitted from one or more data flows using various metadata tags, such as combining all sensor data related to a specific user. The tracking data broker subsequently receives a request from a consumer service for a set of data values that have been tagged with one or more specific metadata tags. The tracking data broker identifies data values that are responsive to the request. In some embodiments, the tracking data broker also identifies a set of data feeds that transmit sensor data that is used to generate the data values that are responsive to the request. The tracking data broker collects a set of data values that are responsive to the request and transmits a message containing the set of data values to the consumer service.

At least one technical advantage of the disclosed techniques relative to the prior art is that, with the disclosed techniques, various data consuming services can acquire sensor data for specific users from multiple tracking data sources in an efficient and scalable manner. In particular, by using a tracking data broker to map users to one or more tracking data sources, the tracking data broker can transmit sensor data acquired by the tracking data sources based on various parameters and filters to a requesting data consuming service without requiring the data consuming service to identify the relevant tracking data sources. In this manner, data consuming services can flexibly acquire sensor data from a large number of tracking data sources to determine information about users with more accuracy and can generate outputs that more accurately reflect the status of each user. Further, by enabling a data consuming service to request a specific suite of sensor data, the tracking data broker can manage multiple tracking data sources by transmit sets of sensor data that are relevant to the data consuming service while filtering other sensor data that do not meet the criteria specified by the data consuming service. Management of tracking data sources and data consuming services in this manger reduces bandwidth and computing resources that are otherwise associated with the data consuming services receiving and discarding unnecessary sensor data. These technical advantages provide one or more technological advancements over prior art approaches.

1. In various embodiments, a computer-implemented method comprises receiving, by a tracking data broker from a consumer, a request for first data tagged with a first set of metadata, determining, by the tracking data broker, a plurality of data feeds associated with the first set of metadata, where a plurality of tracking data sources include, in the plurality of data feeds, sensor data tagged with the first set of metadata, generating a first message containing a set of data values from the plurality of data feeds, and transmitting the first message to the consumer.

2. The computer-implemented method of clause 1, further comprising determining that a first sensor data value included in the set of sensor data values has changed by more than a threshold amount, where the first message is generated in response to the determination.

3. The computer-implemented method of clause 1 or 2, where a second sensor data value included in the set of sensor data values has not changed, and the first message includes the second sensor data value.

4. The computer-implemented method of any of clauses 1-3, where the first set of metadata comprises metadata identifying at least one of: a user identification number, a location, a nominal position, an absolute position, an orientation, a user height, or a user activity level.

5. The computer-implemented method of any of clauses 1-4, where a first tracking data source included in the plurality of tracking data sources is included in a compartment of a vehicle and is associated with a set of sensor metadata indicating a location, an output type, or an accuracy level, and the first tracking data source includes at least one or an audio sensor, a video sensor, a pressure sensor, a gyroscope, an accelerometer, a magnetometer, or an inertial measurement unit (IMU).

6. The computer-implemented method of any of clauses 1-5, further comprising generating, by the tracking data broker, a mapping that identifies, for each tracking data source included in the plurality of tracking data sources, a list of users that are tracked by the tracking data source, determining that the set of metadata includes a first metadata type specifying a first user, and identifying, based on the mapping, a group of data feeds that are associated with the first user.

7. The computer-implemented method of any of clauses 1-6, further comprising receiving, by the tracking data broker, a second request for information for a set of tracking data sources, where the plurality of tracking data sources are included in the set of tracking data sources, generating by the tracking data broker, a second message containing sensor parameters for each tracking data source included in the set of tracking data sources, and transmitting the second message to the consumer.

8. The computer-implemented method of any of clauses 1-7, further comprising receiving, by the tracking data broker from the consumer, a second request for second data tagged with a second set of metadata, determining, by the tracking data broker, a second plurality of data feeds associated with the second set of metadata, where a second plurality of tracking data sources include, in the second plurality of data feeds, second sensor data tagged with the second set of metadata, generating a second message containing a second set of data values from the second plurality of data feeds, and transmitting the second message to the consumer.

9. The computer-implemented method of any of clauses 1-8, where the tracking data broker transmits the second message to the consumer at a different time than the first message.

10. The computer-implemented method of any of clauses 1-9, where transmitting, by the tracking data broker, a plurality of first update messages at a first periodicity, the plurality of first update messages containing sensor data values from the plurality of data feeds, and transmitting, by the tracking data broker, a plurality of second update messages at a second periodicity, the plurality of second update messages containing sensor data values from the second plurality of data feeds.

11. In various embodiments, one or more computer-readable media store instructions that, that, when executed by one or more processors, cause the one or more processors to perform the steps of receiving, by a tracking data broker from a consumer, a request for first data tagged with a first set of metadata, determining, by the tracking data broker, a plurality of data feeds associated with the first set of metadata, where a plurality of tracking data sources include, in the plurality of data feeds, sensor data tagged with the first set of metadata, generating a first message containing a set of data values from the plurality of data feeds, and transmitting the first message to the consumer.

12. The one or more computer-readable media of clause 11, where the request specifies a threshold accuracy level, and each tracking data source included in the plurality of tracking data sources outputs the sensor data above the threshold accuracy level.

13. The one or more computer-readable media of clause 11 or 12, where the first set of metadata includes a first metadata type specifying a sensor data output type, and a second metadata type specifying a first user, and the first data is associated with both the first metadata type and the second metadata type.

14. The one or more computer-readable media of any of clauses 11-13, where the consumer comprises an audio rendering service.

15. The one or more computer-readable media of any of clauses 11-14, the steps further comprising determining that a first sensor data value included in the set of sensor data values has changed above a threshold amount, where the first message is generated in response to the determination, a second sensor data value included in the set of sensor data values has not changed, and the first message includes the second sensor data value.

16. The one or more computer-readable media of any of clauses 11-15, where the first set of metadata comprises metadata identifying at least one of: a user identification number, a location, a nominal position, an absolute position, an orientation, a user height, or a user activity level.

17. The one or more computer-readable media of any of clauses 11-16, the steps further comprising generating, by the tracking data broker, a mapping that identifies, for each tracking data source included in the plurality of tracking data sources, a list of users that are tracked by the tracking data source, determining that the set of metadata includes a first metadata type specifying a first user, and identifying, based on the mapping, a group of data feeds that are associated with the first user.

18. The one or more computer-readable media of any of clauses 11-17, where the first set of metadata comprises metadata identifying at least one of: a sensor type, a sensor location, a sensor accuracy level, or a sensor data output type.

19. The one or more computer-readable media of any of clauses 11-18, where a first tracking data source included in the plurality of tracking data sources is included in a compartment of a vehicle and is associated with a set of sensor metadata indicating a location, an output type, or an accuracy level, and the first tracking data source includes at least one or an audio sensor, a video sensor, a pressure sensor, a gyroscope, an accelerometer, a magnetometer, or an inertial measurement unit (IMU).

20. In various embodiments, a system comprises a memory storing instructions for a tracking data broker, and a processor coupled to the memory that implements the tracking data broker by performing the steps of receiving, by the tracking data broker from a consumer, a request for first data tagged with a first set of metadata, determining, by the tracking data broker, a plurality of data feeds associated with the first set of metadata, where a plurality of tracking data sources include, in the plurality of data feeds, sensor data tagged with the first set of metadata, generating a first message containing a set of data values from the plurality of data feeds, and transmitting the first message to the consumer.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method comprising:
receiving, by a tracking data broker from a consumer, a request for first data tagged with a first set of metadata;
determining, by the tracking data broker, a plurality of data feeds associated with the first set of metadata, wherein a plurality of tracking data sources include, in the plurality of data feeds, sensor data tagged with the first set of metadata;
generating a first message containing a set of data values from the plurality of data feeds; and
transmitting the first message to the consumer.

2. The computer-implemented method of claim 1, further comprising:
determining that a first sensor data value included in the set of sensor data values has changed by more than a threshold amount,
wherein the first message is generated in response to the determination.

3. The computer-implemented method of claim 2, wherein:
a second sensor data value included in the set of sensor data values has not changed; and
the first message includes the second sensor data value.

4. The computer-implemented method of claim 1, wherein the first set of metadata comprises metadata identifying at least one of: a user identification number, a location, a nominal position, an absolute position, an orientation, a user height, or a user activity level.

5. The computer-implemented method of claim 1, wherein:
a first tracking data source included in the plurality of tracking data sources is included in a compartment of a vehicle and is associated with a set of sensor metadata indicating a location, an output type, or an accuracy level; and
the first tracking data source includes at least one or an audio sensor, a video sensor, a pressure sensor, a gyroscope, an accelerometer, a magnetometer, or an inertial measurement unit (IMU).

6. The computer-implemented method of claim 1, further comprising:
generating, by the tracking data broker, a mapping that identifies, for each tracking data source included in the plurality of tracking data sources, a list of users that are tracked by the tracking data source;
determining that the set of metadata includes a first metadata type specifying a first user; and
identifying, based on the mapping, a group of data feeds that are associated with the first user.

7. The computer-implemented method of claim 1, further comprising:
receiving, by the tracking data broker, a second request for information for a set of tracking data sources, wherein the plurality of tracking data sources are included in the set of tracking data sources;
generating by the tracking data broker, a second message containing sensor parameters for each tracking data source included in the set of tracking data sources; and
transmitting the second message to the consumer.

8. The computer-implemented method of claim 1, further comprising:
receiving, by the tracking data broker from the consumer, a second request for second data tagged with a second set of metadata;
determining, by the tracking data broker, a second plurality of data feeds associated with the second set of metadata, wherein a second plurality of tracking data sources include, in the second plurality of data feeds, second sensor data tagged with the second set of metadata;
generating a second message containing a second set of data values from the second plurality of data feeds; and
transmitting the second message to the consumer.

9. The computer-implemented method of claim 8, wherein the tracking data broker transmits the second message to the consumer at a different time than the first message.

10. The computer-implemented method of claim 8, wherein:
transmitting, by the tracking data broker, a plurality of first update messages at a first periodicity, the plurality of first update messages containing sensor data values from the plurality of data feeds; and
transmitting, by the tracking data broker, a plurality of second update messages at a second periodicity, the plurality of second update messages containing sensor data values from the second plurality of data feeds.

11. One or more computer-readable media storing instructions that, that, when executed by one or more processors, cause the one or more processors to perform the steps of:
receiving, by a tracking data broker from a consumer, a request for first data tagged with a first set of metadata;
determining, by the tracking data broker, a plurality of data feeds associated with the first set of metadata, wherein a plurality of tracking data sources include, in the plurality of data feeds, sensor data tagged with the first set of metadata;
generating a first message containing a set of data values from the plurality of data feeds; and
transmitting the first message to the consumer.

12. The one or more computer-readable media of claim 11, wherein:
the request specifies a threshold accuracy level; and
each tracking data source included in the plurality of tracking data sources outputs the sensor data above the threshold accuracy level.

13. The one or more computer-readable media of claim 11, wherein:
the first set of metadata includes:
a first metadata type specifying a sensor data output type, and
a second metadata type specifying a first user; and
the first data is associated with both the first metadata type and the second metadata type.

14. The one or more computer-readable media of claim 11, wherein the consumer comprises an audio rendering service.

15. The one or more computer-readable media of claim 11, the steps further comprising determining that a first sensor data value included in the set of sensor data values has changed above a threshold amount, wherein:
the first message is generated in response to the determination;
a second sensor data value included in the set of sensor data values has not changed; and
the first message includes the second sensor data value.

16. The one or more computer-readable media of claim 11, wherein the first set of metadata comprises metadata identifying at least one of: a user identification number, a location, a nominal position, an absolute position, an orientation, a user height, or a user activity level.

17. The one or more computer-readable media of claim 11, the steps further comprising:
generating, by the tracking data broker, a mapping that identifies, for each tracking data source included in the plurality of tracking data sources, a list of users that are tracked by the tracking data source;
determining that the set of metadata includes a first metadata type specifying a first user; and
identifying, based on the mapping, a group of data feeds that are associated with the first user.

18. The one or more computer-readable media of claim 11, wherein the first set of metadata comprises metadata identifying at least one of: a sensor type, a sensor location, a sensor accuracy level, or a sensor data output type.

19. The one or more computer-readable media of claim 11, wherein:
a first tracking data source included in the plurality of tracking data sources is included in a compartment of a vehicle and is associated with a set of sensor metadata indicating a location, an output type, or an accuracy level; and
the first tracking data source includes at least one or an audio sensor, a video sensor, a pressure sensor, a gyroscope, an accelerometer, a magnetometer, or an inertial measurement unit (IMU).

20. A system comprising:
a memory storing instructions for a tracking data broker; and
a processor coupled to the memory that implements the tracking data broker by performing the steps of:
receiving, by the tracking data broker from a consumer, a request for first data tagged with a first set of metadata;
determining, by the tracking data broker, a plurality of data feeds associated with the first set of metadata, wherein a plurality of tracking data sources include, in the plurality of data feeds, sensor data tagged with the first set of metadata;
generating a first message containing a set of data values from the plurality of data feeds; and
transmitting the first message to the consumer.
